(19) United States
(12) Patent Application Publication
(10) Pub. No.: US 2026/0163644 A1
(43) Pub. Date: Jun. 11, 2026

(54) DEVICES AND METHODS FOR OPTICAL INTERCONNECTS USING POLARIZATION MULTIPLEXING

(71) Applicant: Lightmatter, Inc., Boston, MA (US)

(72) Inventors: Joyce Poon, Toronto (CA); Nikhil Kumar, East Palo Alto, CA (US); Brian Donovan Jones, Jamaica Plain, MA (US); Kuang Liu, Queen Creek, AZ (US); Clifford Chao, Palo Alto, CA (US); Anthony Kopa, Somerville, MA (US); Geoffrey Tu, Mountain View, CA (US); Daniel Stodolsky, Cambridge, MA (US); Darius Bunandar, Boston, MA (US)

(73) Assignee: Lightmatter, Inc, Boston, MA (US)

(21) Appl. No.: 19/413,511

(22) Filed: Dec. 9, 2025

Related U.S. Application Data
(60) Provisional application No. 63/730,082, filed on Dec. 10, 2024.

(51) Int. Cl. H04B 10/40; H04B 10/50; H04B 10/532; H04B 10/61

(52) U.S. Cl. CPC H04B 10/40; H04B 10/506; H04B 10/532; H04B 10/614; H04B 10/6151; H04B 10/6166

(57) ABSTRACT

In optical interconnect systems, information may be encoded in different wavelengths of light in an optical signal in a wavelength division multiplexing (WDM) scheme. The inventors have recognized and appreciated that the data rate of an optical interconnect system may be doubled by employing a polarization multiplexing scheme, where some information is encoded in an optical signal having a first polarization state and other information is encoded in an optical signal having a second, orthogonal polarization state as the different polarizations will act independently while propagating along a fiber. Accordingly, described herein are systems and techniques for optical interconnect systems employing polarization multiplexing.

### CROSS-REFERENCE TO RELATED APPLICATIONS

This application claims the benefit under 35 U.S.C. § 119(e) of U.S. Provisional Application Ser. No. 63/730,082, filed on Dec. 10, 2024, under Attorney Docket No. L0858.70107US00 and entitled “OPTICAL COMMUNICATION WITH POLARIZATION DIVERSITY AND POLARIZATION MULTIPLEXING,” which is hereby incorporated herein by reference in its entirety.

### BACKGROUND

Optical interconnects are a type of communication technology that use light signals to transmit data between different components or devices within a system. These interconnects replace traditional electrical connections, such as copper wires or traces on a circuit board, with optical fibers or waveguides. In optical interconnects, data is converted into light signals using optical transmitters, typically lasers or light-emitting diodes (LEDs) combined with optical modulators. These light signals travel through optical fibers or waveguides, which are made of materials that can efficiently guide and transmit light with minimal loss. At the receiving end, optical receivers convert the incoming light signals back into electrical signals that can be processed by electronic devices.

### SUMMARY

In optical interconnect systems, information may be encoded in different wavelengths of light in an optical signal in a wavelength division multiplexing (WDM) scheme. The inventors have recognized and appreciated that the data rate of an optical interconnect system may be doubled by employing a polarization multiplexing scheme, where some information is encoded in an optical signal having a first polarization state and other information is encoded in an optical signal having a second, orthogonal polarization state as the different polarizations will act independently while propagating along a fiber. Accordingly, described herein are systems and techniques for optical interconnect systems employing polarization multiplexing.

In some aspects, the techniques described herein relate to an optical transceiver, including: an optical fiber port; a transmitter having a first modulator bank and second modulator bank, wherein each modulator bank of the first and second modulator banks is configured to modulate light having wavelengths corresponding to a first set of wavelengths; a receiver having a first receiver bank and second receiver bank, wherein each receiver bank of the first and second receiver banks is configured to receive light having wavelengths corresponding to a second set of wavelengths; and a polarization splitter rotator (PSR) optically coupled to the first and second modulator banks and to the first and second receiver banks, wherein the PSR is configured to: provide a first optical signal received from the first modulator bank and a second optical signal received from the second modulator bank to the optical fiber port, wherein providing the first optical signal to the optical fiber port includes rotating a polarization state associated with the first optical signal, and split light received from the optical fiber port to provide a third optical signal to the first receiver bank and a fourth optical signal to the second receiver bank, wherein splitting the light includes rotating a polarization state associated with the third optical signal.

In some aspects, the techniques described herein relate to an optical transceiver, further including a single mode fiber coupled to the optical fiber port.

In some aspects, the techniques described herein relate to an optical transceiver, further including a first interleaver configured to: provide the modulated light having wavelengths corresponding to the first set of wavelengths from the first modulator bank to the PSR, and provide the third optical signal having wavelengths corresponding to the second set of wavelengths from the PSR to the first receiver bank.

In some aspects, the techniques described herein relate to an optical transceiver, further including a second interleaver configured to: provide the modulated light having wavelengths corresponding to the first set of wavelengths from the second modulator bank to the PSR, and provide the fourth optical signal having wavelengths corresponding to the second set of wavelengths from the PSR to the second receiver bank.

In some aspects, the techniques described herein relate to an optical transceiver, further including: a plurality of polarization controllers, wherein each polarization controller is coupled to the first and second receiver banks.

In some aspects, the techniques described herein relate to an optical transceiver, wherein each polarization controller is configured to control a polarization state associated with light having a wavelength corresponding to a respective one of the second set of wavelengths.

In some aspects, the techniques described herein relate to an optical transceiver, wherein the first receiver bank includes a first plurality of detectors coupled to respective polarization controllers of the plurality of polarization controllers, each detector of the first plurality of detectors is configured to detect light of the third optical signal having a wavelength corresponding to a respective one of the second set of wavelengths.

In some aspects, the techniques described herein relate to an optical transceiver, wherein the second receiver bank includes a second plurality of detectors coupled to respective polarization controllers of the plurality of polarization controllers, each detector of the second plurality of detectors is configured to detect light of the fourth optical signal having a wavelength corresponding to a respective one of the second set of wavelengths.

In some aspects, the techniques described herein relate to an optical transceiver, wherein the first receiver bank includes optical filters configured to filter light from an optical signal, the light having a wavelength corresponding to a respective one of the second set of wavelengths.

In some aspects, the techniques described herein relate to an optical transceiver, wherein the second receiver bank includes optical filters configured to filter light from an optical signal, the light having a wavelength corresponding to a respective one of the second set of wavelengths.

In some aspects, the techniques described herein relate to an optical transceiver, further including an input optical fiber port coupled to the first modulator bank.

In some aspects, the techniques described herein relate to an optical transceiver, wherein rotating the polarization state associated with the first optical signal includes rotating the polarization state from TE to TM.

In some aspects, the techniques described herein relate to an optical transceiver, wherein rotating the polarization state associated with the third optical signal includes rotating the polarization state by approximately 90°.

In some aspects, the techniques described herein relate to an optical transceiver, wherein wavelengths of the first set of wavelengths alternate with wavelengths of the second set of wavelengths.

In some aspects, the techniques described herein relate to an optical transceiver, wherein wavelengths of the first set of wavelengths are contiguous and wavelengths of the second set of wavelengths are contiguous.

In some aspects, the techniques described herein relate to an optical transceiver, including: a first optical fiber port and a second optical fiber port; a transmitter having a first modulator bank and second modulator bank, wherein each modulator bank of the first and second modulator banks configured to modulate light having wavelengths corresponding to a first set of wavelengths; a first polarization splitter rotator (PSR) coupled between the first optical fiber port and the first and second modulator banks, the first PSR configured to: provide a first optical signal received from the first modulator bank and a second optical signal received from the second modulator bank to the first optical fiber port, wherein providing the first optical signal to the optical fiber port includes rotating a polarization state associated with the first optical signal; a receiver having a first receiver bank and second receiver bank, wherein each receiver bank of the first and second receiver banks is configured to receive light having wavelengths corresponding to a second set of wavelengths; and a second PSR coupled between the second optical fiber port and the first and second receiver banks, the second PSR configured to: split light received from the second optical fiber port to provide a third optical signal to the first receiver bank and a fourth optical signal to the second receiver bank, wherein splitting the light includes rotating a polarization state associated with the third optical signal.

In some aspects, the techniques described herein relate to an optical transceiver, further including a first single mode fiber coupled to the first optical fiber port and a second single mode fiber coupled to the second optical fiber port.

In some aspects, the techniques described herein relate to an optical transceiver, further including an input optical fiber port coupled to the first modulator bank.

In some aspects, the techniques described herein relate to an optical transceiver, wherein rotating a polarization state associated with the first optical signal includes rotating the polarization state from TE to TM.

In some aspects, the techniques described herein relate to an optical transceiver, wherein rotating the polarization state associated with the third optical signal includes rotating the polarization state by approximately 90°.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear. In the figures:

FIG. 1 shows an example optical transceiver employing polarization multiplexing, according to some embodiments;

FIG. 2 shows another example optical transceiver employing polarization multiplexing, according to some embodiments; and

FIG. 3 shows another example optical transceiver employing polarization multiplexing, according to some embodiments.

### DETAILED DESCRIPTION

Described herein are systems and methods for enabling and improving optical communication in optical interconnect systems employing polarization multiplexing.

Conventional optical communication systems typically rely on wavelength division multiplexing (WDM) to increase data transmission bandwidth in optical fibers. Namely, WDM schemes are used in optical interconnect systems to transmit multiple signals simultaneously over a single optical fiber by encoding information in optical signals having different wavelengths of light. This allows for the efficient use of the fiber's bandwidth and significantly increases the data-carrying capacity.

The inventors have recognized that the data transmission bandwidth of optical fibers can be further increased by employing a polarization multiplexing scheme where different signals are encoded in light having two orthogonal polarization states, thereby doubling the amount of information that can be transmitted on a given fiber. This polarization multiplexing scheme may be employed in addition to WDM, significantly increasing the overall transmission bandwidth of the optical interconnect system.

Some embodiments employ polarization maintaining (PM) optical fibers to support polarization multiplexing. PM fibers are engineered to preserve the polarization state of the incoming signal. However, PM fibers are typically more expensive and exhibit higher loss than standard single mode fibers, making them practical only for relatively short distances. Accordingly, further embodiments use single mode fibers. Use of single mode fibers, however, introduces a challenge. As light propagates through the fiber, its polarization state undergoes unpredictable rotation. To address this issue, some embodiments employ polarization splitter rotators (PSRs) to reconstruct the polarization state received at the end of a fiber. PSRs are optical devices configured to split incoming optical signals into first mode optical signals having a first polarization state and second mode optical signals having a second polarization state orthogonal to the first polarization state, and to rotate the polarization state of one of the signals to match that of the other signals.

Polarization multiplexing schemes may be implemented by the optical transceivers described herein in various manners. In some embodiments, the optical transceiver may have separate optical paths for the transmit and receive sides of the transceiver. In these schemes, an optical fiber supports communication in one direction and a separate optical fiber supports communication in the opposite direction. The optical paths may have separate polarization splitter rotators (PSRs), where the first PSR ensures that two optical signals have orthogonal polarizations during transmission and the second PSR ensures that the two optical signals have the operational polarization of the receiver. This simplifies the overall architecture of the optical transmitter because it separates the transmitter from the receiver on the substrate.

Alternatively, the transmitter and the receiver may communicate with external devices through the same optical fiber. These optical transceivers may have a single optical fiber port, and may employ interleavers to properly route signals through the interconnected optical paths. The interleavers may be designed to promote selective coupling using a combination of constructive and destructive interference to route the optical signals between the transmit and receive optical paths in an optical transceiver. Wavelengths that are coupled from the transmitter to an optical fiber thanks to constructive interference do not couple to the receiver because of destructive interference. Similarly, wavelengths that are coupled from the optical fiber to the receiver thanks to constructive interference do not couple to the transmitter because of destructive interference. The routing through optical interleavers may be achieved using interferometers designed to provide spectral responses that are I-shifted relative to one another. For example, at one terminal, the interferometer may exhibit a certain spectral response and, at another terminal, the interferometer may exhibit a T-shifted spectral response. Some embodiments employ asymmetric Mach Zehnder interferometers (MZI) to produce this effect.

Embodiments described herein are directed towards optical transceivers configured to support a bidirectional, polarization multiplexed optical communication system. For example, the optical transceivers may be implemented as photonic integrated circuits (PICs) of a WDM, polarization multiplexed optical interconnect system. The optical communication system may include a plurality of nodes that communicate with each other, one or more of which may comprise the optical transceivers described herein.

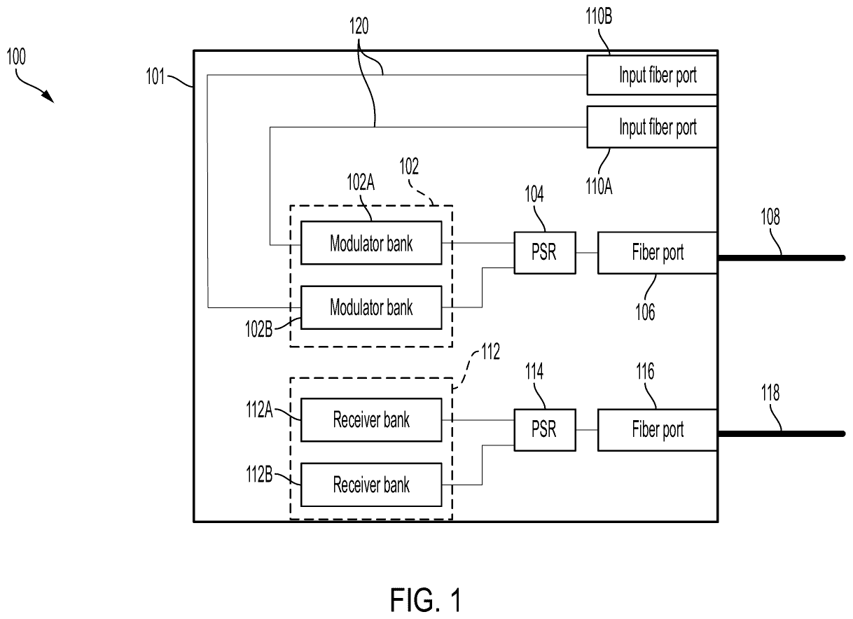

FIG. 1 is an example optical transceiver 100 employing polarization multiplexing, according to some embodiments. This scheme employs distinct optical fibers; one fiber to transmit light outside the transceiver and another fiber to receive light at the transceiver. Optical transceiver 100 comprises a transmitter 102, a receiver 112, PSRs 104 and 114, and optical fiber ports 106 and 116. Optical transceiver 100 is implemented as a PIC with components disposed on substrate 101. A plurality of waveguides 120 may be formed in substrate 101 to optically couple the various components of optical transceiver 100. In some embodiments, optical transceiver 100 may include additional components not shown in FIG. 1 including, but not limited to, laser inputs, controllers, electrical connections between controllers and other components, analog-to-digital converters (ADCs), digital-to-analog converters (DACs), and monitoring photodiodes.

Optical transceiver 100 may be configured to transmit optical signals through optical fiber 108 and to receive optical signals through optical fiber 118. Optical fiber 108 is optically coupled to substrate 101 by optical fiber port 106, which may comprise an edge coupler, a grating coupler, a prism coupler, or any other suitable fiber-substrate coupling mechanism. In some embodiments, optical fiber 108 may comprise a single mode fiber. Similarly, optical fiber 118 is optically coupled to substrate 101 by optical fiber port 116.

Transmitter 102 may be configured to transmit optical signals comprising a set of carrier wavelengths (λ₁, λ₂, λ₃, . . . λ₈). Transmitter 102 comprises a first modulator bank 102A configured to modulate input light from input fiber port 110A to encode a first optical signal and a second modulator bank 102B configured to modulate input light from input fiber port 110B to encode a second optical signal. Although two input fiber ports are shown, it can be appreciated that a single input fiber port may be used where the single input fiber port is optically coupled to both the first and second modulator banks 102A and 102B. The input fiber port(s) may be optically coupled to one or more laser inputs (not shown) to provide the input light comprising the set of carrier wavelengths.

Modulator banks 102A and 102B may comprise a micro-ring modulator bank having a plurality of micro-ring modulators. Each of the plurality of micro-ring modulators may be configured to encode the input light having a respective carrier wavelength of the set of carrier wavelengths. In this way, first modulator bank 102A generates a first optical signal comprising encoded light having the set of carrier wavelengths and second modulator bank 102B generates a second optical signal comprising encoded light having the same set of carrier wavelengths. This makes it possible to encode two independent data streams onto the same set of wavelengths, effectively doubling the transmission bandwidth.

The first and second optical signals may be transmitted from transmitter 102 to PSR 104 prior to being transmitted through optical fiber 108. PSR 104 is configured to generate a combined optical signal from the first optical signal and second optical signal. As the input light provided by the modulator banks may be in the same polarization state (typically TE), PSR 104 may be configured to rotate one of the first or second optical signals (e.g., by approximately 90°) so that the resulting first optical signal and second optical signal have orthogonal polarizations (e.g., from the TE to the TM mode). Then PSR 104 may combine the non-rotated and rotated optical signals to generate the combined optical signal to be transmitted through optical fiber 108. Although a single mode fiber supports only one spatial mode (typically, the HE₁₁ fundamental mode), it supports two orthogonal polarization states of that mode, which can be used as separate channels for polarization multiplexing. By encoding information into orthogonal polarization states, the bandwidth of transceiver 100 is doubled relative to non-polarization multiplexing schemes.

On the receive side, optical receiver 112 is configured to receive optical signals through optical fiber 118. The optical signals may be received through optical fiber 118 as a combined optical signal (e.g., generated and transmitted by another polarization multiplexed optical transceiver) of two orthogonally polarized states. As the transmit and receive sides of optical transceiver 100 are independent in the implementation of FIG. 1, there is no risk of interference between the transmit path and the receive path. As such, the combined optical signal received by optical receiver 112 may have the same (e.g., λ₁, h₂, h₃, . . . λ₈) or a different set of carrier wavelengths (λ₉, λ₁₀, λ₁₁, . . . λ₁₆) than is used by transmitter 102.

The combined optical signal may be received first at PSR 114. PSR 114 may be configured to split the combined optical signal into a first optical signal having a first polarization state and a second optical signal having a second, orthogonal polarization state. In some embodiments, receiver 112 may be configured to operate in one polarization state (e.g., the TE mode, corresponding to the polarization state having the lowest loss). As such, PSR 114 may be configured to rotate the optical signal received in the other polarization (e.g., the TM mode) to the operational polarization (e.g., the TE mode).

Optical receiver 112 comprises a first receiver bank 112A configured to receive the first optical signal from PSR 114 and a second receiver bank 112B configured to receive the second optical signal from PSR 114. When received at receiver 112, both signals exhibit the desired polarization state (e.g., TE). First and second receiver banks 112A and 112B may comprise a plurality of wavelength filters configured to filter light of respective wavelengths of the set of carrier wavelengths from the first and second optical signals. Each wavelength filter may be coupled to an optical detector (e.g., photodiode) to transform the optical signal encoded in the respective wavelength received by the filter into an electrical signal. In some embodiments, the wavelength filters may comprise coupled ring resonators.

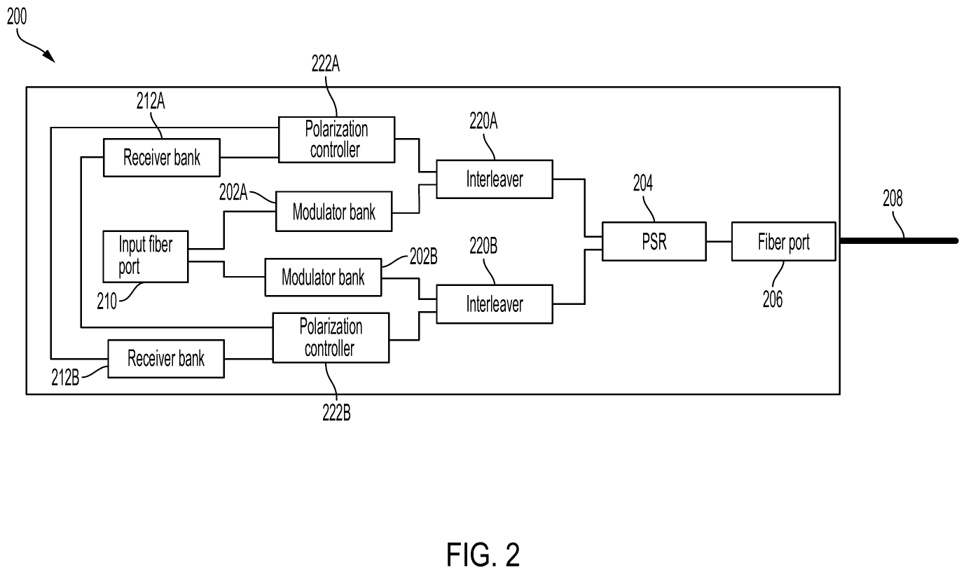

In the scheme of FIG. 1, the transmitter and the receiver employ separate fibers. In other schemes, a common fiber may be used. This scheme reduces the physical footprint that the optical transceiver may occupy on a substrate. FIG. 2 is an example optical transceiver 200 employing polarization multiplexing over a common fiber, according to some embodiments. Similar to optical transceiver 100, optical transceiver 200 includes an optical transmitter comprising a first modulator bank 202A and a second modulator bank 202B and a receiver comprising a first receiver bank 212A and second receiver bank 212B. The transmitter and receiver may be configured in a similar manner as described above with respect to transmitter 102 and receiver 112. However, while the transmit and receive sides of optical transceiver 100 are independent, some of the optical connections between the transmit and receive sides of optical transceiver 200 are shared. Namely, rather than including two optical fiber ports and PSRs, optical transceiver 200 supports bidirectional communication through a single optical fiber port 206 and single PSR 204. PSR 204 is configured to perform both of the operations described above with respect to PSRs 104 and 114, including rotating and combining signals to generate a combined optical signal having orthogonal polarization states, and splitting a received optical signal into the first and second optical signals having the same polarization state. Further, optical transceiver 200 has additional components including interleavers 220A and 220B and polarization controllers 222A and 222B to properly route the two polarization multiplexed optical signals.

Optical transceiver 200 may be configured to receive and transmit optical signals through optical fiber 208. Optical fiber 208 is optically coupled to substrate 201 by fiber port 206, which may comprise an edge coupler, a grating coupler, a prism coupler, or any other suitable fiber-substrate coupling mechanism. Optical fiber 208 may comprise a single mode optical fiber or a PM fiber.

In some embodiments, optical transceiver 200 is configured to receive optical signals having one or more of a first set of carrier wavelengths (λ₁, λ₂, λ₃, . . . λ₈) and transmit optical signals having one or more of a second set of carrier wavelengths (λ₉, λ₁₀, λ₁₁, . . . λ₁₆). To avoid interference as the signals travel along optical fiber 208, the carrier wavelengths of the first set and the second set may be non-overlapping. In some embodiments, the first set and the second set may be assigned distinct bands of contiguous carrier wavelengths. In some embodiments, the wavelengths of the first set and the second set may alternate with each other (e.g., λ₁, λ₉, λ₂, λ₁₀ . . . λ₈, λ₁₆).

On the receiver side of optical transceiver 200, optical signals are received via optical fiber 208 by PSR 204. The optical signals may be combined optical signals having a first data signal in a first polarization state and a second data signal in a second, orthogonal polarization state. As single mode fibers may cause polarization drift, the combined optical signals may be received by PSR 204 as a mix of two orthogonal modes (e.g., the TE and TM mode). Each of the first data signal and second data signal may have portions in the TE and the TM polarization component. PSR 204 may split the received signal into a first mode optical signal (e.g., the TE mode signal) and a second mode optical signal (e.g., the TM mode signal). The polarization state of the second mode optical signal may then be rotated to match the polarization state of the first mode optical signal. The first mode optical signal is then provided to the first interleaver 220A and the second mode optical signal is provided to the second interleaver 220B.

Interleaver 220A may be optically coupled between the first modulator bank 202A and PSR 204 by a first port of interleaver 220A. Interleaver 220A may further be optically coupled between the first receiver bank 212A and PSR 204 by a second port of interleaver 220A. The constructive and destructive interference introduced by interleaver 220A prevents received optical signals from PSR 204 to be coupled with the modulator banks of the transmitter.

As light propagates through a single mode fiber, the two orthogonal polarization states of the fundamental mode may undergo arbitrary rotation relative to their original orientations. For example, although a transmitter may launch two orthogonal polarization states, their orientations at the fiber output may be rotated by an unpredictable angle, even though the orthogonality between the states is typically preserved. To recover these states and present them to the PIC in the TE mode recognized by on-chip waveguides, the transceiver may employ polarization controllers 222A and 222B, in combination with the PSR. In some embodiments, the polarization controllers are implemented as interferometers that include actively tunable phase shifters in their branches. By appropriately adjusting the phase shifts applied by these phase shifters, the polarization controllers aligns the incoming polarization with the TE mode in combination with the PSR. Together, the polarization controllers and the PSR effectively unscramble the polarization states received at the end of the fiber. In some embodiments, polarization controller 222A may be configured as a 2×2 Mach-Zehnder interferometer (MZI), a dual-stage MZI, a three-stage MZI, or any other suitable type of optical interferometer.

Interleaver 220B may be coupled between second modulator bank 202B, second receiver bank 212B and PSR 204, and may be configured in a similar manner as interleaver 220A to route optical signals between the components of optical transceiver 200. Further, polarization controller 222B may be configured in a similar manner as polarization controller 222A to split the second mode optical signal into its first data signal component and second data signal component to provide each to their respective receiver banks 212A and 212B.

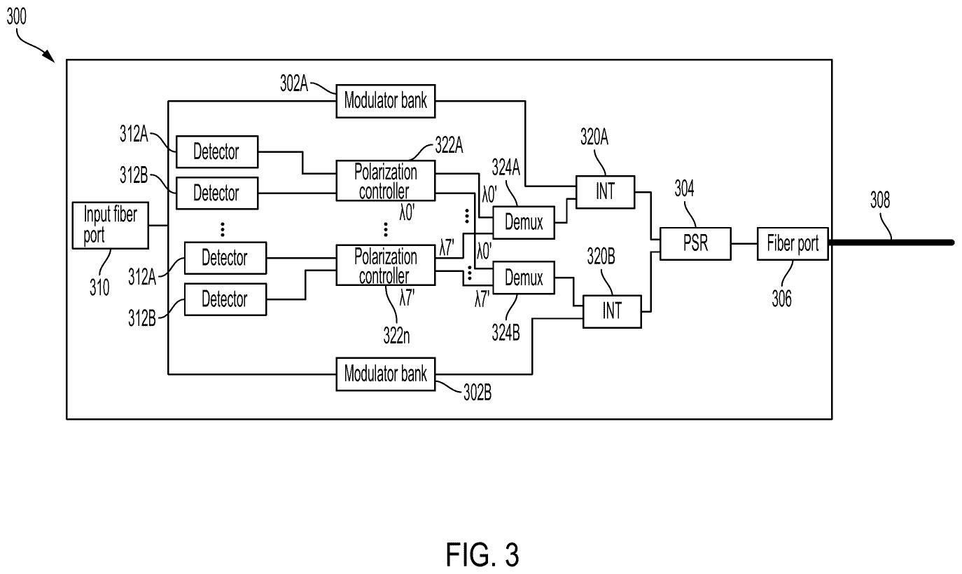

In some embodiments, polarization controller 222A-222B may be broadband polarization controllers, where the entire set of carrier wavelengths of the first mode optical signal are split simultaneously. However, different wavelengths may experience different degrees of polarization rotation, given the wavelength-dependent nature of the polarization dispersion effect, especially over relatively long distances. As the polarization states of different wavelengths drift further apart, broadband polarization controllers may be unsuitable for splitting the signal into first data signal components and second data signal components. Accordingly, in some embodiments, a plurality of narrowband polarization controllers may be used, each of which is tuned to a respective wavelength of the receiver set of carrier wavelengths. FIG. 3 is an example optical transceiver 300 employing polarization multiplexing with narrowband polarization controllers, according to some embodiments. Optical transceiver 300 is similar to the above-discussed optical transceivers 100 and 200 in that optical transceiver comprises a transmitter comprising a first modulator bank 302A and second modulator bank 302B and a receiver comprising a first receiver bank (e.g., detectors 312A) and second receiver bank (e.g., detectors 312B). The transmitter side of optical transceiver 300 is configured in a similar manner as discussed above with respect to optical transceiver 200. However, the configuration of the receiver side of optical transceiver 300 may demultiplex the first mode optical signal and second mode optical signal into separate signals of different carrier wavelengths prior to providing the signals to the polarization controllers 322A-n. In that way, n narrowband polarization controllers 322 (e.g., one for each carrier wavelength, although only two are illustrated) may be used, each tuned to a respective carrier wavelength.

Rather than providing the first mode optical signals and second mode optical signals directly to a broadband polarization controller (e.g., as in FIG. 2), interleavers 320A and 320B may be configured to provide the first mode optical signals and second mode optical signals to first and second wavelength demultiplexers 324A and 324B, respectively. Wavelength demultiplexers 324A and 324B may comprise a plurality of wavelength filters, each tuned to filter respective wavelengths of the receiver's set of carrier wavelengths. The wavelength filters may each be coupled to respective polarization controllers 322A-n to provide signals of respective carrier wavelengths to each of the controllers. In some embodiments, the wavelength filters of wavelength demultiplexers 324A and 324B may comprise coupled ring resonators.

Polarization controllers 322A-n may be configured in a similar manner as described above with respect to polarization controller 222A to divide the signals into first data signal components and second data signal components.

As the wavelength filtering in this example embodiment is performed by wavelength demultiplexers 324A and 324B prior to polarization controllers 322, the receiver banks may only comprise optical detectors. The first receiver bank comprising detectors 312A may be configured to receive the first data signal components (e.g., from the first data signal transmitted in the first polarization) from polarization controllers 322 whereas the second receiver bank comprising detectors 312B may be configured to receive the second data signal components (e.g., from the second data signal transmitted in the second, orthogonal polarization) from polarization controllers 322. Detectors 312A and 312B may comprise photodetectors each tuned to detect light of a respective wavelength of the receiver's set of carrier wavelengths and generate a respective electrical signal based on the detected light.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments. The definitions, as defined and used herein, should be understood to control over dictionary definitions, definitions in documents incorporated by reference and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some case and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately,” “substantially,” and “about” may be used to mean within ±20% of a target value in some embodiments. The terms “approximately,” “substantially,” and “about” may include the target value.

Use of ordinal terms such as “first,” “second,” “third,” etc., in the claims to modify a claim element does not by itself connotate any priority, precedence, or order of one claim element over another or the temporal order in which acts of a method are performed, but are used merely as labels to distinguish one claim element having a certain name from another claim element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The terms “couple,” “coupled,” and “coupling,” when used in connection with optical components, are to be interpreted broadly to include both direct and indirect coupling. Two optical components are considered directly coupled if there are no intervening components between them. In contrast, two optical components are considered indirectly coupled if there is at least one intervening component between them, provided that the intervening component does not alter the general nature of the interaction between the optical components.

1. An optical transceiver, comprising:
an optical fiber port;
a transmitter having a first modulator bank and second modulator bank, wherein each modulator bank of the first and second modulator banks is configured to modulate light having wavelengths corresponding to a first set of wavelengths;
a receiver having a first receiver bank and second receiver bank, wherein each receiver bank of the first and second receiver banks is configured to receive light having wavelengths corresponding to a second set of wavelengths; and
a polarization splitter rotator (PSR) optically coupled to the first and second modulator banks and to the first and second receiver banks, wherein the PSR is configured to:
provide a first optical signal received from the first modulator bank and a second optical signal received from the second modulator bank to the optical fiber port, wherein providing the first optical signal to the optical fiber port comprises rotating a polarization state associated with the first optical signal, and
split light received from the optical fiber port to provide a third optical signal to the first receiver bank and a fourth optical signal to the second receiver bank, wherein splitting the light comprises rotating a polarization state associated with the third optical signal.

2. The optical transceiver of claim 1, further comprising a single mode fiber coupled to the optical fiber port.

3. The optical transceiver of claim 1, further comprising a first interleaver configured to:
provide the modulated light having wavelengths corresponding to the first set of wavelengths from the first modulator bank to the PSR, and
provide the third optical signal having wavelengths corresponding to the second set of wavelengths from the PSR to the first receiver bank.

4. The optical transceiver of claim 3, further comprising a second interleaver configured to:
provide the modulated light having wavelengths corresponding to the first set of wavelengths from the second modulator bank to the PSR, and
provide the fourth optical signal having wavelengths corresponding to the second set of wavelengths from the PSR to the second receiver bank.

5. The optical transceiver of claim 4, further comprising:
a plurality of polarization controllers, wherein each polarization controller is coupled to the first and second receiver banks.

6. The optical transceiver of claim 5, wherein each polarization controller is configured to control a polarization state associated with light having a wavelength corresponding to a respective one of the second set of wavelengths.

7. The optical transceiver of claim 6, wherein the first receiver bank comprises a first plurality of detectors coupled to respective polarization controllers of the plurality of polarization controllers, each detector of the first plurality of detectors is configured to detect light of the third optical signal having a wavelength corresponding to a respective one of the second set of wavelengths.

8. The optical transceiver of claim 7, wherein the second receiver bank comprises a second plurality of detectors coupled to respective polarization controllers of the plurality of polarization controllers, each detector of the second plurality of detectors is configured to detect light of the fourth optical signal having a wavelength corresponding to a respective one of the second set of wavelengths.

9. The optical transceiver of claim 1, wherein the first receiver bank comprises optical filters configured to filter light from an optical signal, the light having a wavelength corresponding to a respective one of the second set of wavelengths.

10. The optical transceiver of claim 9, wherein the second receiver bank comprises optical filters configured to filter light from an optical signal, the light having a wavelength corresponding to a respective one of the second set of wavelengths.

11. The optical transceiver of claim 1, further comprising an input optical fiber port coupled to the first modulator bank.

12. The optical transceiver of claim 1, wherein rotating the polarization state associated with the first optical signal comprises rotating the polarization state from TE to TM.

13. The optical transceiver of claim 1, wherein rotating the polarization state associated with the third optical signal comprises rotating the polarization state by approximately 90°.

14. The optical transceiver of claim 1, wherein wavelengths of the first set of wavelengths alternate with wavelengths of the second set of wavelengths.

15. The optical transceiver of claim 1, wherein wavelengths of the first set of wavelengths are contiguous and wavelengths of the second set of wavelengths are contiguous.

16. An optical transceiver, comprising:
a first optical fiber port and a second optical fiber port;
a transmitter having a first modulator bank and second modulator bank, wherein each modulator bank of the first and second modulator banks configured to modulate light having wavelengths corresponding to a first set of wavelengths;
a first polarization splitter rotator (PSR) coupled between the first optical fiber port and the first and second modulator banks, the first PSR configured to:
provide a first optical signal received from the first modulator bank and a second optical signal received from the second modulator bank to the first optical fiber port, wherein providing the first optical signal to the optical fiber port comprises rotating a polarization state associated with the first optical signal;
a receiver having a first receiver bank and second receiver bank, wherein each receiver bank of the first and second receiver banks is configured to receive light having wavelengths corresponding to a second set of wavelengths; and
a second PSR coupled between the second optical fiber port and the first and second receiver banks, the second PSR configured to:
split light received from the second optical fiber port to provide a third optical signal to the first receiver bank and a fourth optical signal to the second receiver bank, wherein splitting the light comprises rotating a polarization state associated with the third optical signal.

17. The optical transceiver of claim 16, further comprising a first single mode fiber coupled to the first optical fiber port and a second single mode fiber coupled to the second optical fiber port.

18. The optical transceiver of claim 16, further comprising an input optical fiber port coupled to the first modulator bank.

19. The optical transceiver of claim 16, wherein rotating a polarization state associated with the first optical signal comprises rotating the polarization state from TE to TM.

20. The optical transceiver of claim 16, wherein rotating the polarization state associated with the third optical signal comprises rotating the polarization state by approximately 90°.
